(19) United States
(12) Patent Application Publication
(10) Pub. No.: US 2010/0278449 A1
(43) Pub. Date: Nov. 4, 2010

(54) METHOD FOR STREAMLINED IMPLEMENTATION OF INTERPOLATION IN MULTIPLE DIMENSIONS

(76) Inventor: Roman Gitlin, Rehovot (IL)

Correspondence Address: Roman Gitlin, PO Box 1004, Rehovot, 76110, IL

(21) Appl. No.: 12/766,889

(22) Filed: Apr. 25, 2010

Related U.S. Application Data
(60) Provisional application No. 61/174,373, filed on Apr. 30, 2009.

(51) Int. Cl. G06K 9/36

(52) U.S. Cl. 382/277

(57) ABSTRACT

A method for efficiently implementing a multi-dimensional interpolation in a way which is predicated on dynamic interpolation-input makeup, the method comprising: processing, said interpolation's first interpolation-input and said interpolation's second interpolation-input, prior to processing said interpolation's third interpolation-input, processing said interpolation's third interpolation-input as a recursion.

### CROSS REFERENCE TO RELATED APPLICATIONS

This application claims the benefit of U.S. Provisional Patent Application Ser. No. 61/174,373, filed Apr. 30, 2009 by the present inventor. This Provisional Patent Application is incorporated herein by reference.

### FEDERALLY SPONSORED RESEARCH

Not Applicable

### TECHNICAL FIELD

This invention is related to the field of multi-dimensional interpolation.

### BACKGROUND ART

In a majority of cases, to perform an interpolation in multiple dimensions with a necessary degree of precision, the interpolation has to be implemented by breaking it up into a chain of one-dimensional interpolations.

In prior art, though, breaking a multi-dimensional interpolation up into a chain of one-dimensional interpolations has been a structural given. Case in point, in ‘Numerical Recipes’ (W.H. Press et al., Numerical Recipes (The Art of Scientific Computing), 3rd Edition, Cambridge University Press, Chapter 3, “3.6 Interpolation on a Grid in Multidimensions,” 2007, p. 133) the book authors describe their implementations of interpolations in the dimension two as ‘grabbing pieces of “machinery” from . . . one-dimensional interpolation classes’.

### SUMMARY OF THE INVENTION

In accordance with a feature of the present invention we have discerned, and demonstrated in this invention's embodiments, that there is a structural link between multi-dimensional interpolation local and global properties, the link that we, in accordance with yet another feature of the present invention, have utilized with dramatic improvements both in multi-interpolation efficiency and in multi-interpolation ease of implementation.

As demonstrated in this invention's embodiments, computer-implementing a multi-dimensional interpolation in a way which is predicated on this structural link results in multi-interpolation speedups that, rather than measuring in percentage points, measure in orders of magnitude.

### BRIEF DESCRIPTION OF DRAWINGS

FIG. 1 shows an exemplary layout of a three-dimensional grid.

FIGS. 2A and 2B show an exemplary layout of a three-dimensional interpolation object.

FIG. 3 shows an exemplary layout of an N-dimensional grid.

FIG. 4 shows an exemplary layout of an N-dimensional interpolation object

FIG. 5 shows an exemplary family of interpolation-stage-specific graphs, each depicting local, global-interpolation-stage-specific interpolation input incidence rates.

FIGS. 6A through 6E show an exemplary two-stage implementation of locally optimized local input processing hierarchies.

FIGS. 7A through 7F show an exemplary three-stage implementation of locally optimized local input processing hierarchies

FIGS. 8A through 8D show an exemplary two-stage implementation of a globally optimized dynamic interpolation-input processing hierarchy.

FIGS. 9A through 9E depict an exemplary three-stage implementation of a globally optimized dynamic interpolation-input processing hierarchy.

FIGS. 10A and 10B depict an exemplary layout of parsing a three-dimensional interpolation data-base.

FIG. 11 shows an exemplary flow-chart of processing a three-dimensional third interpolation-input as an implemented-by-algorithmically-global-one-dimensional-methods recursion.

FIG. 12 shows an exemplary flow-chart of processing a three-dimensional third interpolation-input as an implemented-by-algorithmically-local-one-dimensional-methods recursion.

FIG. 13 shows an exemplary layout of processing a three-dimensional third interpolation-input in a multi-node computer system in communication over a network.

FIGS. 14, 15, 16, 17, and 18 depict an exemplary layout of a method and apparatus for computer-generating multi-dimensional interpolation means of a user-defined type, said means being implemented in accordance with the present invention features.

### DESCRIPTION

### Glossary

In Computer Science in general, and in prior art in particular, a set-theoretical definition of a function has not been viewed as having any practical value. Case in point, a set-theoretical definition of a function is not as far as mentioned in Microsoft COMPUTER DICTIONARY, Fifth Edition.

Therefore, since a number of issues in the present invention description are framed in set-theoretical functional terms, it is necessary for us to define a few, mostly function related terms as they are used in this description and in the appendant claims.

Tangibly stored Function—a Definition: as used in this description and in the appendant claims, we define tangibly stored function as a function stored in a computer storage medium in a way which unambiguously defines:
(a) the function domain,
(b) the function range, and
(c) the function's complete set of argument-value/function-value-at-argument-value pairs.
   For example, a function F={(3, 7), (5,7), (9,7), (11, 7), (13, 5), (14, 7)} tangibly stored as a pair of vectors <3, 5, 9, 11, 13, 7 > and <7, 7, 7, 7, 5, 7 > is a tangibly stored function.

Notation: as used in this description and in the appendant claims, a plain reference to function will mean a reference to a tangibly stored function.

Interpolation—a first Definition: as used in this description and in the appendant claims, we define interpolation as computing the function-value at an argument-node based on the function domain and the function range.

Interpolated Function—a Definition: as used in this description and in the appendant claims, we define interpolated function as a tangibly stored function.

Redundant Input-Processing—a Definition: within the context of interpolation in multiple dimensions, as used in this description and in the appendant claims, we define redundant input-processing as processing the same input by the same program multiple times such that all but a single instance of said processing can be eliminated in a way that does not affect functionality of the program, i. e., the program input/output characteristics as they appear to the user, e. g., computational results, screen displays, output files, etc.

Redundant Input-Processing free interpolation, substantially as described—a Definition: within the context of interpolation in multiple dimensions, as used in this description and in the appendant claims, we define substantially-redundant input-processing as a redundant input-processing whose cost grows at a rate faster than O(N), N being the number of dimensions.

Accordingly, as used in this description and in the appendant claims, we define “redundant input-processing free interpolation, substantially as described” as an interpolation that is substantially-redundant input-processing free.

Redundant-Overhead free Interpolation, substantially as described—a Definition: as used in this description and in the appendant claims, within the context of interpolation in multiple dimensions, we define redundant overhead as an overhead whose elimination does not affect functionality of the program, i. e., the program input/output characteristics as they appear to the user, e. g., computational results, screen displays, output files, etc.

As used in this description and in the appendant claims, within the context of interpolation in multiple dimensions, we define substantially-redundant overhead as a redundant overhead whose cost grows with the number of dimensions at a rate faster than O(N), N being the number of dimensions.
Accordingly, as used in this description and in the appendant claims, we define “redundant-overhead free interpolation, substantially as described”, as an interpolation that is substantially-redundant overhead free.

Redundant-Stack-Grows free Interpolation, substantially as described—a Definition: as used in this description and in the appendant claims, within the context of interpolation in multiple dimensions, we define redundant stack-grows as a stack grows that can be eliminated without affecting functionality of the program, i. e., the program input/output characteristics as they appear to the user, e. g., computational results, screen displays, output files, etc.

As used in this description and in the appendant claims, within the context of interpolation in multiple dimensions, we define substantially-redundant stack-grows as a redundant stack-grows with a grows rate faster than O(N), N being the number of interpolation dimensions.
Accordingly, as used in this description and in the appendant claims, we define “redundant stack-grows free interpolation, substantially as described” as an interpolation that is substantially-redundant stack-grows free.
Tangibly Implemented Function—a Definition: as used in this description and in the appendant claims, we define tangibly implemented function as a function implemented as an instruction set.

Interpolating Function—a Definition: as used in this description and in the appendant claims, we define interpolating function as a tangibly implemented function that:
(a) takes an interpolated function domain, range, and associated argument value as its first, second, and third arguments respectively, and
(b) upon being called with an interpolated function's domain, range, and an associated argument node, returns the interpolated function's value at the argument node based on the interpolated function's domain and range.

Stand-alone Interpolating Function—a Definition: as used in this description and in the appendant claims, we define stand-alone interpolating function as an interpolating function whose instruction set is not a subset of another interpolating function instruction set.

Interpolation—a second Definition: as used in this description and in the appendant claims, we define interpolation as a stand-alone interpolating function call.

Nested interpolating Function—a Definition: as used in this description and in the appendant claims, we define nested interpolating function as an interpolating function whose instruction set is a proper subset of another interpolating function instruction set.

Local Interpolation Input—a Definition: as used in this description and in the appendant claims, we define local interpolation input as a union of a nested interpolating function's first, second, and third argument values.

Static Interpolation Input—a Definition: as used in this description and in the appendant claims, we define static interpolation input as a union of a stand-alone interpolating function first, second, and third argument values.

First Interpolation Input—a Definition: as used in this description and in the appendant claims, we define first interpolation input as a stand-alone interpolating function's first argument value.

Second Interpolation Input—a Definition: as used in this description and in the appendant claims, we define second interpolation input as a stand-alone interpolating function's second argument value.

Third Interpolation Input—a Definition: as used in this description and in the appendant claims, we define third interpolation input as a union of a stand-alone interpolating function third argument value (i.e., interpolation data-base) and the totality of intermediate data bases that are incrementally generated during said function single call.

For example, in case of a three-dimensional interpolating function, the interpolating function's third interpolation input is a union of:

(a) said three-dimensional interpolating function three-dimensional interpolation data-base (i.e., the interpolating function third argument value),

(b) a two-dimensional interpolation data base generated during the interpolating function first interpolation stage, and

(c) a one-dimensional interpolation data base generated generated during the interpolating function second interpolation stage.

Dynamic Interpolation Input—a Definition: as used in this description and in the appendant claims, we define dynamic interpolation-input as a union of a stand-alone interpolating function's first, second, and third interpolation-inputs.

Code partitioning Means: code-refactoring techniques are intrinsically reliant on storage means as well as data-accessing means. Accordingly, as used in this description and in the appendant claims, we will be referring to code-refactoring/code-partitioning techniques as code-refactoring/code-partitioning means.

Interpolation Objects: while the present invention's preferred embodiments are written in C++ computer language, other computer implementations of multidimensional interpolation providing functionality that lies within the present invention's spirit and scope can be written in other computer languages as well. C, Scheme, Java, Smalltalk, D, and E are but a few examples of such languages. While older computer languages are not object-oriented, some of the more recent computer languages, besides being object-oriented, are also network-oriented. Accordingly, as used in this description and in the appendant claims, we use the term “object” as reference to an instruction set that, in a fashion particular to the application at hand, provides a range of object- and network-like attributes and services (e.g., data location within a network, prioritized data access, data and function encapsulation, etc.).

### Multi_Dimensional Interpolation, A Three-Dimensional Example

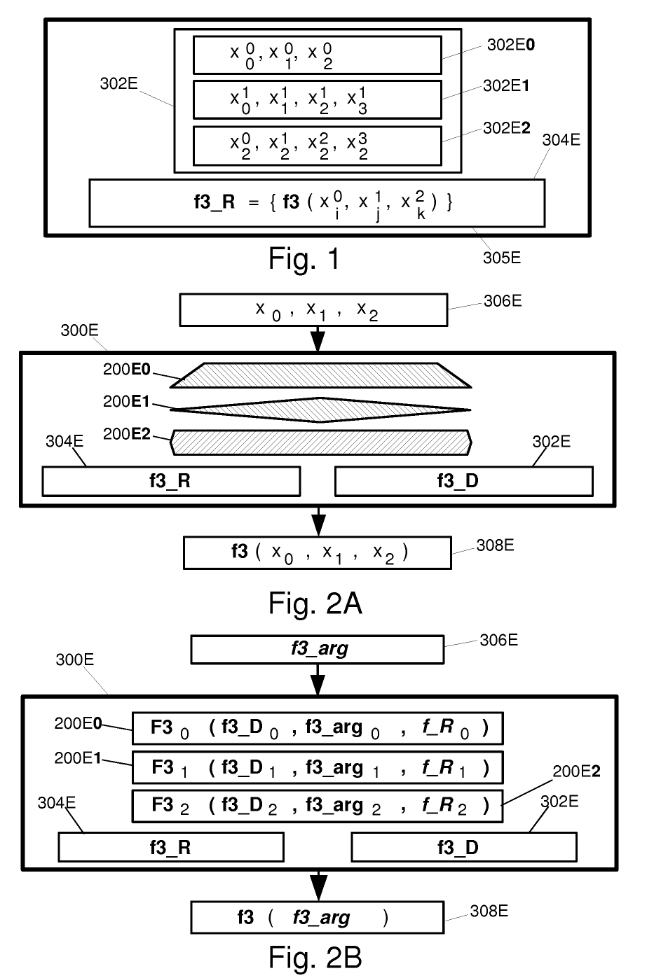

FIG. 1 shows a tangibly stored three-dimensional grid 305E consisting of a mesh 302E, and a data-base 304E of function f3 values at a Cartesian product of argument tables 302E0, 302E1, and 302E2.

FIG. 2A shows an exemplary layout of a three dimensional interpolation object 300E that interpolates on grid 305E and has access, by some accessing means (e.g., pointer means), to mesh 302E and data_base 304E. Object 300E is shown as being coupled, by some coupling means (e.g., reference means), to three one-dimensional interpolation objects, 200E0, 200E1, and 200E2, each dedicated to implementing one of object 300 three interpolation stages.

At this stage of the description, we will assume that objects 200E0, 200E1, and 200E2 interpolate on the entire range of their respective argument tables.

We will discuss the case of algorithmically-local one-dimensional nested interpolation objects applied for implementation of interpolation in multiple dimensions later in the disclosure.

### Interpolating Function/Interpolated Function (IFIF) Interpolation Model

In this section we will discuss the “IFIF” interpolation model and establish this model utility as a descriptive tool. To that end first we will re-define a stand-alone interpolation object 300E as a stand-alone interpolating function F3. Then we will redefine nested interpolation one-dimensional objects 200E0, 200E1, and 200E2 as nested interpolating functions F3₀, F3₁, and F3₂ respectively.

In the process we will establish that any stand-alone interpolation object instruction set implements a stand-alone interpolating function, and that any nested one-dimensional interpolating object instruction set implements a nested interpolating function.

### Tangibly Stored Grid Is A Tangibly Stored Interpolated Function

We observe that grid 305E is a tangibly stored function since:
(a) grid's mesh 302E unambiguously defines function f3 domain f3_D by virtue of being an aggregation of function f3 domain f3_D tangibly stored Cartesian factors 300E0, 300E1, and 300E2,
(b) grid's data-base 302E is function f3 tangibly stored range f3_R, and
(c) mesh 302E and data-base 302E unambiguously define the function's f3 complete set of argument-value/function-value-at-argument-value pairs:

f3={<(x⁰ᵢ,x¹ⱼ,x²ₖ),f3(x⁰ᵢ,x¹ⱼ,x²ₖ)>i=0,1,2 j=0,1,2,3 k=0,1,2,3}or,

in an abbreviated form

f3={f3(x⁰ᵢ,x¹ⱼ,x²ₖ) i=0,1,2 j=0,1,2,3 k=0,1,2,3}

### Stand-Alone Interpolation Object is a Stand-Alone Interpolating Function

We observe that object 300E is a stand-alone interpolating function since:
(a) interpolation object 300E interpolates on interpolated function f3,
(b) object 300E instruction set is not a proper subset of any other interpolation object instruction set, and
(c) upon receiving function's f3 associated argument value ƒ3_arg object 300E returns function value f3(ƒ3_arg) based on the function domain f3_D and the function range f3_R.

Thus, by defining an interpolating function F3 in terms of object 300E instruction set as

F3(f3_{—}D,f3_arg,f3_{—}R)=f3(f3_arg)

we redefine object 300E as a stand-alone interpolating function.

### Nested Interpolation Object is a Nested Interpolating Function

To re-define interpolation objects 200E0, 200E1, and 200E2 (FIG. 2A) as nested interpolating functions F3₀, F3₁, and F3₂ (FIG. 2B) we will step through three of object 300E interpolation stages, as interpolation object 300E is called with an argument value f3_arg=(x₀, x₁, x₂).

At object's 300E first interpolation stage, by constraining interpolated function f3 to its first argument value, a family of one-dimensional functions/one-dimensional grids {h1ⱼₖ} is formed:

h1ⱼₖ(x)=f3(x,x¹ⱼ,x²ₖ) (j,k=0,1,2,3) (1)

Each of thus defined grids h1ⱼₖ consists of:
(a) the grid's argument table

f3_D₀=(x⁰₀,x⁰₁,x⁰₂), and (2)
(b) the grid's known values

h1ⱼₖ(x⁰₀)=f3(x⁰₀,x¹ⱼ,x²ₖ)

h1ⱼₖ(x⁰₁)=f3(x¹₀,x¹ⱼ,x²ₖ)

h1ⱼₖ(x⁰₂)=f3(x⁰₂,x¹ⱼ,x²ₖ) (3)

We observe that all of the h1ⱼₖ grids share the same argument table f3_D₀.

Object 200E0 interpolates on each of h1ⱼₖ grids at fixed argument value f3_arg₀=x₀ to generate a two-dimensional interpolation data-base {Hⱼₖ} to be processed by object 200E1 instruction set ring object 300E next, two-dimensional interpolation stage:

{Hⱼₖ=h1ⱼₖ(x₀)=f3(xₒ,x¹ⱼ,x²ₖ)} (4)

At object's 300E second interpolation stage, by constraining interpolated function f3 to its second argument value, a family of one-dimensional functions/one-dimensional grids {h2ₖ} is formed:

h2ₖ(x)=f3(x₀,x,x²ₖ) (k=0,1,2,3) (5)

Each of grids h2ₖ consists of:
(a) the grid's argument table

f3_{—}D₁=(x¹₀,x¹₁,x¹₂,x¹₃), and (6)
(b) the grid's known values

h2ₖ(x¹₀)=f3(x₀,x¹₀,x²ₖ)

h2ₖ(x¹₁)=f3(x₀,x¹₁,x²ₖ)

h2ₖ(x¹₂)=f3(x₀,x¹₂,x²ₖ)

h2ₖ(x¹₃)=f3(X₀,x¹₃,x²₁). (7)

We observe that all of the grid family {h2ₖ} members share the same argument table f3_D₁.

Object 200E1 interpolates on each of h2ₖ grids at fixed argument value f3_arg₁=x₁ to generate a one-dimensional interpolation data-base {Hₖ} to be processed by object 300E instruction set during object 300E next, one-dimensional interpolation stage:

{Hₖ=h2ₖ(Xᵢ)=f3(x₀,x₁,x²ₖ)} (8)

At object's 300E third and final interpolation stage, by further constraining function f3 to its third argument, a function h3 defined:

h3(x)=f3(x₀,xᵢ,x) (9)

Function h3 is also a one-dimensional grid consisting of
(a) the grid's argument table

f3_{—}D₂=(x²₀,x²₁,x²₂,x²₃) (10)
(b) the grid's known values

h3(x²₀)=f3(x₀,x₁,x²₀)

h3(x²₁)=f3(x₀,x₁,x²₁)

h3(x²₂)=f3(x₀,x₁,x²₂)

h3(x²₃)=f3(x₀,x₁,x²₃). (11)

Object 200E2 interpolates on grid h3 at argument value f3_arg₂=x₂ to generate a function value f3(x₀, x₁, x₂)

H=f3(x₀,x₁,x₂)=h3(x₂) (12)

Thus, object 300E interpolation at argument value (x₀, x₁, x₂) is complete.

At this point we are ready to re-define nested interpolation objects 200E0, 200E1, and 200E2 as nested interpolating functions F3₀, F3₁, and F3₂ respectively.

We will define object's 200Ei respective interpolated functions ƒᵢ first.

We define object's 200E0 interpolated function ƒ₀ as a shared extension of {h1ⱼₖ} family of functions:
function ƒ₀ domain is functions' {h1ⱼₖ} shared domain f3_D₀(2),
function ƒ₀ varying-range's set of values ƒ_{0—}R is formed by functions' h1ⱼₖ varying ranges (3).

We observe that during object's 300E first interpolation stage (a) both function ƒ₀ domain f3_D₀ and function ƒ₀ argument value f3_arg₀ remain constant, and (b) function ƒ₀ range ƒ_{0—}R varies.

We define object's 200E1 interpolated function ƒ₁ as a shared extension of {h2ₖ} family of functions (5):
function ƒ₁ domain is functions' h2ₖ shared domain f3_D₁(6).
function ƒ₁ varying-range's set of values ƒ_{1—}R is formed by functions' {h2ₖ} set of ranges (7)

We observe that during object's 300E first interpolation stage (a) function ƒ₁ domain f3_D₁ and function ƒ1 argument value f3_arg₁ remain constant, and (b) function ƒ₁ range ƒ_{1—}R varies.

We define object's 200E2 interpolated function f₂ as function h3 (9):
function f₂ domain is function's h3 domain f3_D₂ (10).
function f₂ range is function's h3 range (11).

We observe that both function ƒ₂ domain f3_D₂ and function ƒ₂ argument value f3_arg₂ remain constant during object's 300E third interpolation stage by default.

We finally observe that during object 300E i-th interpolation stage, for each of function's ƒᵢ range ƒᵢ_R values interpolation objects 200Ei returns function ƒᵢ value ƒᵢ(f3_argᵢ) based on function ƒᵢ constant domain f3_Dᵢ and function's ƒᵢ range value ƒ_Rᵢ(i32 0, 1, 2).

Thus, by defining each of interpolating functions F3ᵢ in terms of objects 200Ei respective instruction sets,

F3ᵢ(f3_{—}Dᵢ,f₁₃ argᵢ,ƒ_{i—}R)=ƒᵢ(f3_argᵢ)i=0,1,2

we redefine each of objects 200Ei as a nested interpolation function.

At this point of the description we reiterate what should be now apparent to a person skilled in the art: the “IFIF” model neither imposes any constraints on, nor changes in any way the substance of what interpolation in multiple dimensions is.

FIG. 2B shows object 300E re-defined as a stand-alone interpolating function F3: interpolating function F3 300E interpolates on grid 305E and has access, by some accessing means (e.g., pointer means), to mesh 302E and data_base 304E. Interpolating function F3 is coupled, by some coupling means (e.g., reference means), to three nested, one-dimensional interpolating functions, F3₀ 200E0, F3₁ 200E1, and F3₂200E2, each dedicated to implementing one of interpolating function F3 three interpolation stages.

### Multi_Dimensional Interpolation, A General Layout

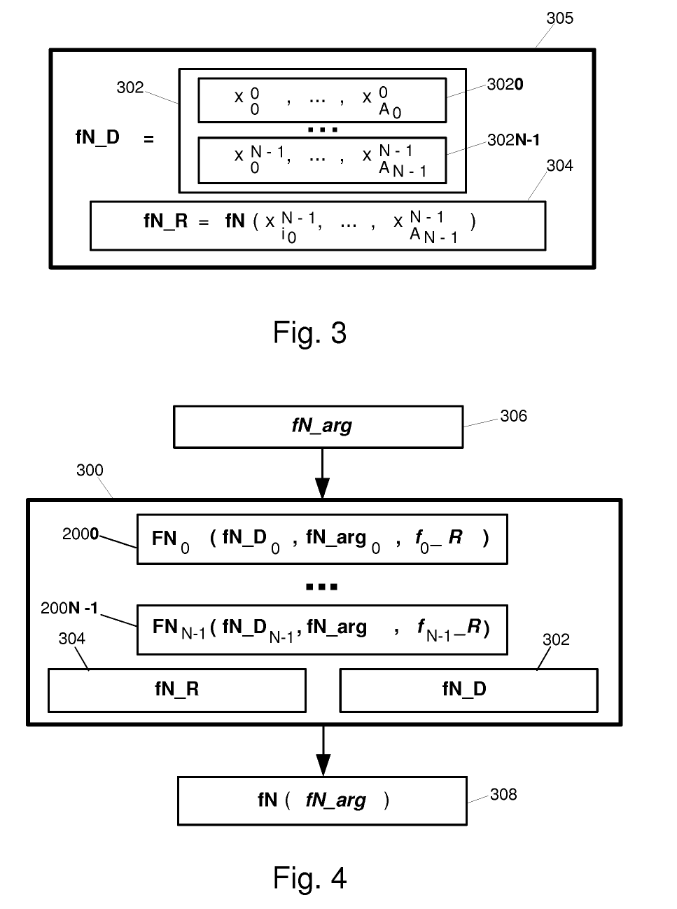

FIG. 3 shows a tangibly stored N-dimensional grid 305 consisting of a mesh 302 and a range 304 of function fN values at a Cartesian product of N argument tables, argument table 3020 through argument table 302N−1.

FIG. 4 shows an exemplary layout of a generic, stand-alone N-dimensional interpolating function FN 300 that has access, by some accessing means (e.g. inclusive means), to function's fN domain fN_D 302 and function's fN range fN_R 304, and is coupled, by some coupling means (e.g. reference means), to N one-dimensional interpolating nested functions FN₀ 2000, . . . , FN_{N-1} 200N−1, each function FNᵢ implementing function FN i-th interpolation stage.

Upon receiving function's fN associated argument value fN_arg 306, function FN returns value fN(fN_arg) 308 based on function fN domain fN_D 302 and function fN range fN_R 304.

Hereinafter in the disclosure, without loss of generality and for illustrative purposes only, we will be using interpolating function FN as a structurally-evolving reference point.

Thus it will be appreciated that using interpolating function FN as an evolving reference point neither restricts, nor is interned to restrict, the spirit and the scope of the present invention.

Until we state otherwise, we will confine the description of the invention to the case of optimizing a single interpolation call.

To facilitate understanding of this invention by a person skilled in the art, we will restrict, until we state otherwise, the description of the invention to those of the present invention's embodiments that are implemented on a single-node computer system.

Later in the description, the present invention's embodiments in a parallel computing environment will be described as well.

### Static Interpolation Input

As it is well known to those skilled in the art, processing a compound input that has its components' relative incidence rates stratified can often be optimized by resorting to some kind of prioritized-processing scheme. It is stratified incidence rates, though, that make such a prioritized-processing scheme work. And there is no stratified input incidence rates within static multi-dimensional interpolation input: during function FN single call incidence rate of the grid's mesh 302 is one, incidence rate of function FN second argument value (interpolated function fN argument node) is one, and incidence rate of function FN third argument value is one as well.

### Dynamic Interpolation Input

In accordance with this invention's yet another feature, we found a way of efficiently implementing multi-dimensional interpolation in a way that is predicated of interpolation-input makeup. It is a different interpolation-input, though, processing of which we optimize.

In accordance with this invention yet another feature, rather then trying to tweak the way we process conventionally defined interpolation-input, in a conceptual breakthrough, from static to the dynamic, we expand the notion of what interpolation-input is.

Then, as demonstrated in the present invention embodiments, we optimize interpolation in multiple dimensions in a way that is predicated on dynamic interpolation-input makeup (see Glossary).

### Implementing Interpolation in Multiple Dimensions in a Way which is Predicated on Dynamic Interpolation-Input Makeup

### Local Interpolation-Input Incidence Rates

We observe that for each of function FN calls the following holds:

(1) function's FNᵢ first argument value fN_Dᵢ remains constant during said call.

(2) function's FNᵢ second argument value fN_argᵢ remains constant during said call.

(3) Unless interpolated function fN is a constant function, function FNᵢ third argument values f_{i—}R vary during each of function fN calls.

That in turn means that for each of interpolating function FN calls, at each of function FN interpolation stages:
functions FNᵢ third argument values occurrence-rate is an integer multiple of
function FNᵢ first argument singular instance occurrence rate, and
functions FNᵢ third argument values occurrence-rate is the-same-integer
multiple of function FNᵢ second argument singular instance occurrence rate.

Thus, as we have discerned in accordance with yet another feature of this invention and demonstrated in the present invention preferred embodiments, that in turn means that gains in multi-dimensional interpolation speed that exponentially grow with the number of dimensions can be realized by just processing interpolating function's FNᵢ first and second argument values before processing function FNᵢ third argument value.

Also, as we have discerned in accordance with yet another feature of this invention, that also means that:

(a) all of redundant data-processing in a multi-dimensional interpolation on a grid occurs locally,

(b) all of redundant data-processing in a multi-dimensional interpolation on a grid stems from concurrently processing local interpolation input components that feature distinct occurrence rates, and

(c) eliminating redundant input-processing in a multi-dimensional interpolation is predicated on local interpolation-input incidence rates being stratified.

### Locally Implemented Means For Globally Eliminating Redundant-Input-Processing In Multi- Dimensional Interpolation

### Local Interpolation Input Occurence-Tree

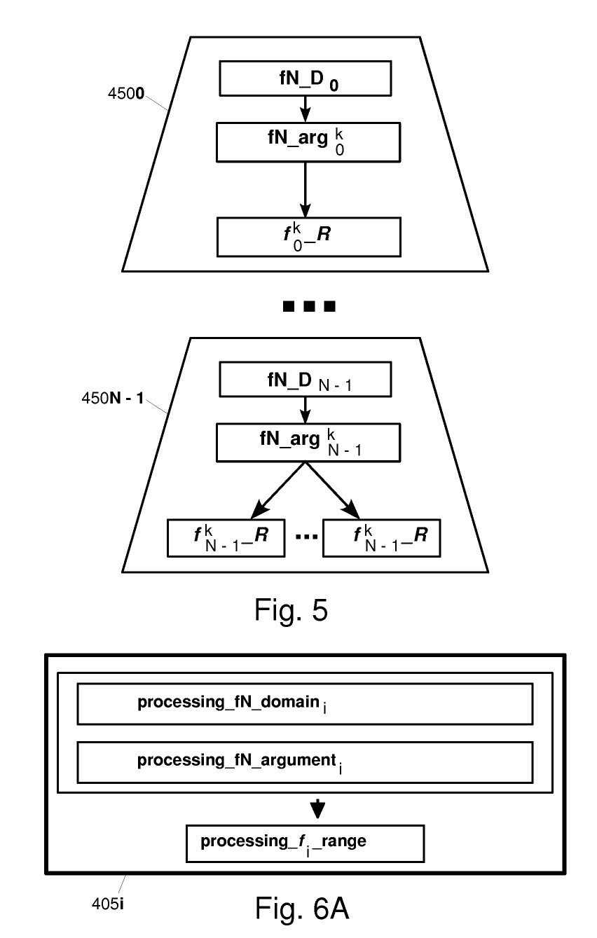

FIG. 5 shows function's FNᵢ first, second, and third argument values that occur during function FN single call, said argument values are shown forming a local-input stratified-occurrence-rates tree 450i, i=0, . . . , N−1, wherein

Function's FNᵢ first argument value is the tree's root.

Function's FNᵢ second argument value is the tree's mid-level singular node.

Function's FNᵢ third argument multiple values are the tree's multiple leafs.

### Multi-Dimensional-Interpolation Local Processing-Thread

Each of local-input stratified-occurrence-rates 450i paths can be viewed as representing:

(a) A single set of function FNᵢ first, second, and third argument values.

(b) An interpolating-function's FNᵢ single processing-thread.

### Locally Implemented Means for Eliminating Redundant-Input-Processing in Multi-Dimensional Interpolation: A Two-Stage Implementation

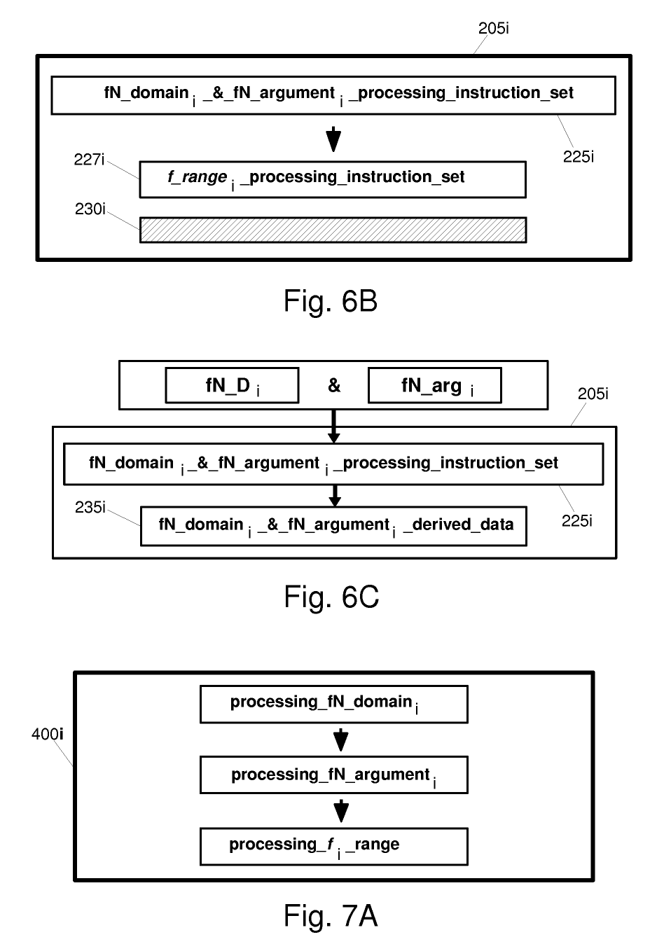

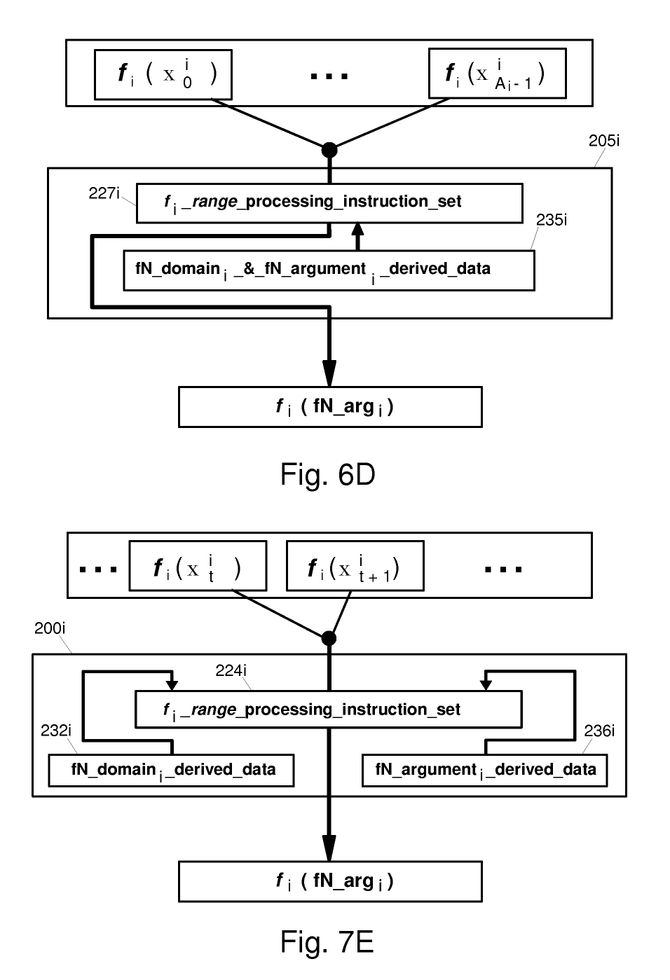

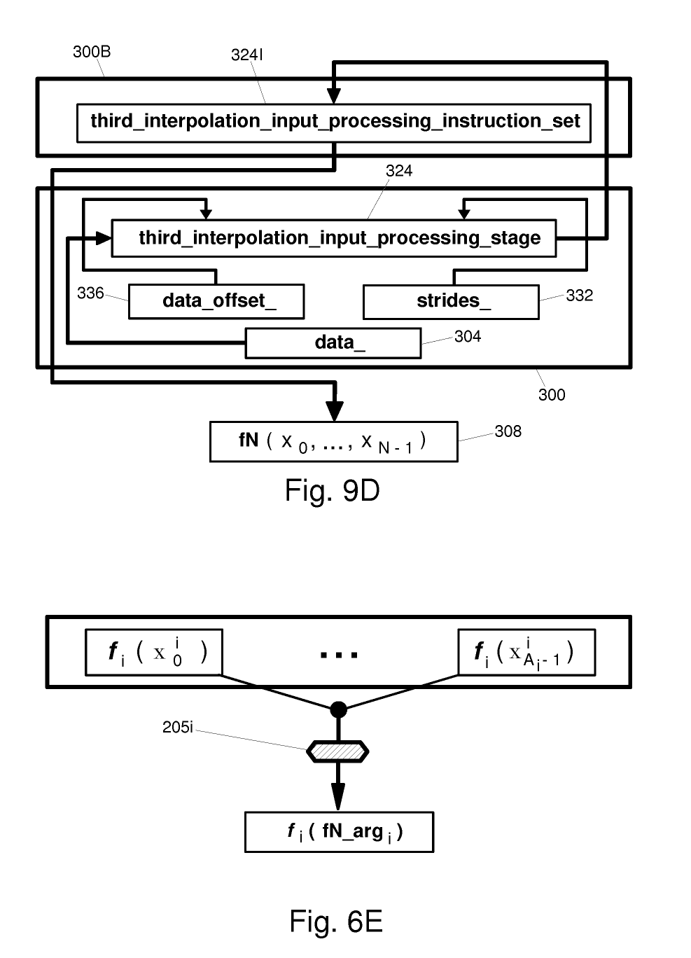

FIG. 6A shows an exemplary layout of function FNᵢ processing flow-chart 405i two-stage-optimized in a way predicated on local interpolation-input stratified incidence rates (FIG. 5).

FIG. 6B shows an exemplary layout of interpolating function FNᵢ 205i, the function instruction set shown to be code-partitioned in compliance with processing hierarchy 405i:
instruction set 225i is dedicated to processing function's FNᵢ first and second argument values prior to function's FNᵢ 205i third argument values being processed, instruction set 227i, is dedicated to processing function's FNᵢ 205i third argument values.

The above arrangement is necessarily hardware-supported: as depicted in FIG. 6B, a storage space 230i that enables function FNᵢ 205i instruction set to be thus-partitioned, is allocated in a computer readable-writable storage medium within interpolating object 205i.

FIG. 6C shows object's function FNᵢ 205i first instructions set 225i processing function's FNᵢ 205i first and second argument values in order to (a) generate and (b) tangibly store, within storage space 230i, function's FNᵢ 205i data set 235i which is necessary for processing of function FNᵢ 205i third argument value during function FNᵢ 205i next processing stage.

FIG. 6D shows object's 205i second instructions set 227i processing—in reliance on function FNᵢ 205i data set 235i—function's FNᵢ 205i third argument values.

FIG. 6D also shows instructions set 227i, upon having function's FNᵢ 205i third argument value processed, returning function value ƒᵢ (xᵢ).

We will now delineate why conditions 405i, once implemented, eliminate redundant data processing in multi-dimensional interpolation substantially as described:

During each of interpolating function FN calls, interpolating functions' FNᵢ 205i instruction sets are the only instruction subsets within function FN instruction set that are repeatedly called, with a frequency rate that grows exponentially with the number of dimensions.

During each of interpolating function FN calls, interpolating function FNᵢ 205i first and second argument values constitute the only constant input that nested interpolating functions FNᵢ process during interpolating function FN single call.

During each of interpolating function FN calls, interpolating function FNᵢ 205i first and function FNᵢ 205i second argument value are processed one time each.

That in turn means that, during each of function FN calls, the only kind of redundant data-processing that can possibly occur would result from concurrently processing function FNᵢ first and second argument values, and during each of the function FN interpolation stages that concurrent processing is performed once.

This in turn means that, during each of function FN calls, the amount of redundant data processing could grow at most at a rate O(N), N being the number of of dimensions.

This in turn means that a multi-dimensional interpolation whose local-input processing sequence is partitioned in accordance with conditions 405i, is redundant input-processing free, substantially as described.

### Locally Implemented Means for Globally Eliminating Redundant Input-Processing in Multi-Dimensional Interpolation: A Three-Stage Implementation

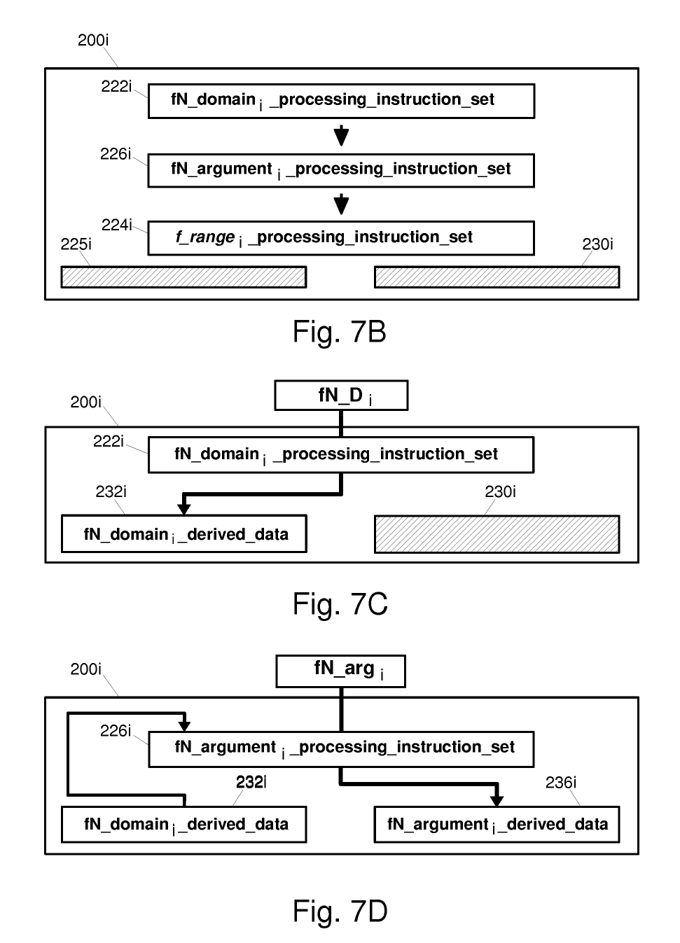

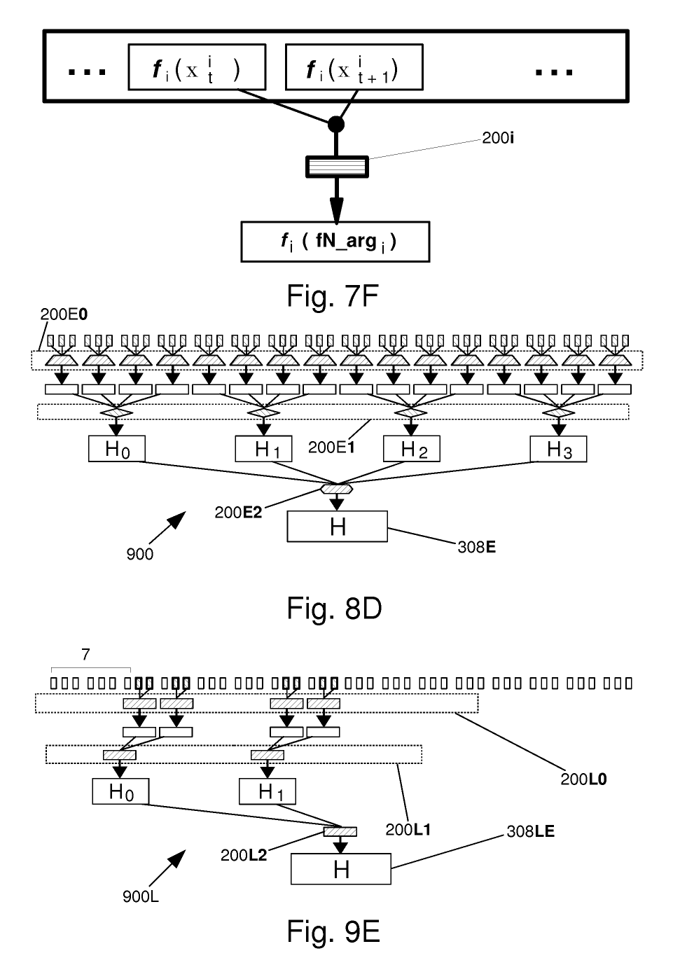

FIG. 7A shows an exemplary layout of the ith-interpolation-stage-specific three-stage processing flow-charts 400i optimized in a way predicated on the local-input-occurrence-tree 450i (i =0, . . . , N−1).

FIG. 7B shows an exemplary layout of function FNᵢ 200i total instruction set being decomposed-and-redistributed in compliance with flowchart 400i: instruction sets 222i being dedicated to processing function FNᵢ 200i first argument value prior to function FNᵢ 200i second argument value being processed, instruction sets 226i being dedicated to processing function FNᵢ 200i second argument value prior to function FNᵢ 200i third argument values being processed, instruction sets 224i is dedicated to processing function FNᵢ 200i third argument values.

The above arrangements is necessarily hardware-supported:

As depicted in FIG. 7B, a first and a second storage spaces, 225i and 230i, are allocated in a computer storage medium within interpolating object 200i.

FIG. 7C shows object's 200i first instructions set 222i processing function's FNᵢ 200i first argument value in order to (a) generate and (b) tangibly store, within object's 200i first storage space 225i, function's FNᵢ 200i first data set 232i necessary for processing function's FNᵢ 200i second and third argument values.

FIG. 7D shows function's FNᵢ 200i second instructions set 226i processing—in reliance on function FNᵢ 200i first data set 232i—function FNᵢ 200i second argument value in order to (a) generate and (b) tangibly store, within function's FNᵢ 200i second storage space 230i, function's FNᵢ 200i second data set 236i necessary for processing function's FNᵢ 200i third argument values.

FIG. 7E shows function's FNᵢ 200i third instructions set 224i processing—in reliance on function's FNᵢ 200i first and second data sets, 232i and 236i—function's FNᵢ 200i third argument values.

FIG. 7E also shows instructions set 224i, upon having function FNᵢ 200i third argument value processed, returning function value ƒᵢ (xᵢ).

We will now delineate why conditions 400i, once implemented, eliminate redundant data processing in multi-dimensional interpolation:

During each of interpolating function FN calls interpolating functions' FNᵢ 200i instruction sets are the only instruction subsets within function FN instruction set that are repeatedly called with a frequency rate that grows exponentially with the number of dimensions.

During each of interpolating function FN single calls interpolating function FNᵢ 200i first and second argument values constitute the only constant input that nested interpolating functions FNᵢ 200i process.

During each of interpolating function FN single calls, interpolating function FNᵢ 200i first and second argument values are processed one time each.

This in turn means that a multi-dimensional interpolation whose local-input processing is partitioned in accordance with processing hierarchy 400i, is redundant input-processing free.

### Eliminating Redundant-Input-Processing in Multi-Dimensional Interpolation Globally, Substantially as Described

In accordance with yet another feature of this invention, we have discerned, and demonstrated in this invention embodiments, that eliminating redundant data processing in a multi-dimensional interpolation, substantially as described, can be computer-implemented by:
(IIL) processing, said interpolation first interpolation-input and said interpolation second interpolation-input, prior to processing said interpolation third interpolation input.

### Processing Sequence (IIL): Global-to-Local/Local-to-Global Structural Link

Once interpolating function FN processing sequence has been (IIL)-code-partitioned, it breaks up into N interpolation-stage-specific local processing chronologies, each mandating:
processing, interpolating function FNᵢ first argument value and interpolating function FNᵢ second argument value, prior to processing function FNᵢ third argument values.

In accordance with the present invention yet another feature, we observe that the above described local interpolation-input processing hierarchies, which are global-interpolation-input-makeup-imposed, are structurally identical to local-input processing hierarchies 405i, which are local-input stratified-incidence-rates-imposed (FIG. 6A).

Thus, in accordance with the present invention yet another feature, we observe that locally-optimized processing hierarchies 405i are mandated by globally-optimized processing sequence (IIL).

Thus, we observe, eliminating redundant input-processing in multi-dimensional interpolation, substantially as described, is predicated on both local interpolation-input makeup and global interpolation-input makeup. Thus, eliminating redundant input-processing in multi-dimensional interpolation, substantially as described, is predicated on interpolation-input makeup.

### Computer-Implementating Processing Sequence (IIL)

We further observe that since jointly-extended local-input-processing-hierarchies 405i define global processing hierarchy (IIL) this structural connection can serve as a blueprint for implementing global input processing hierarchy (IIL).

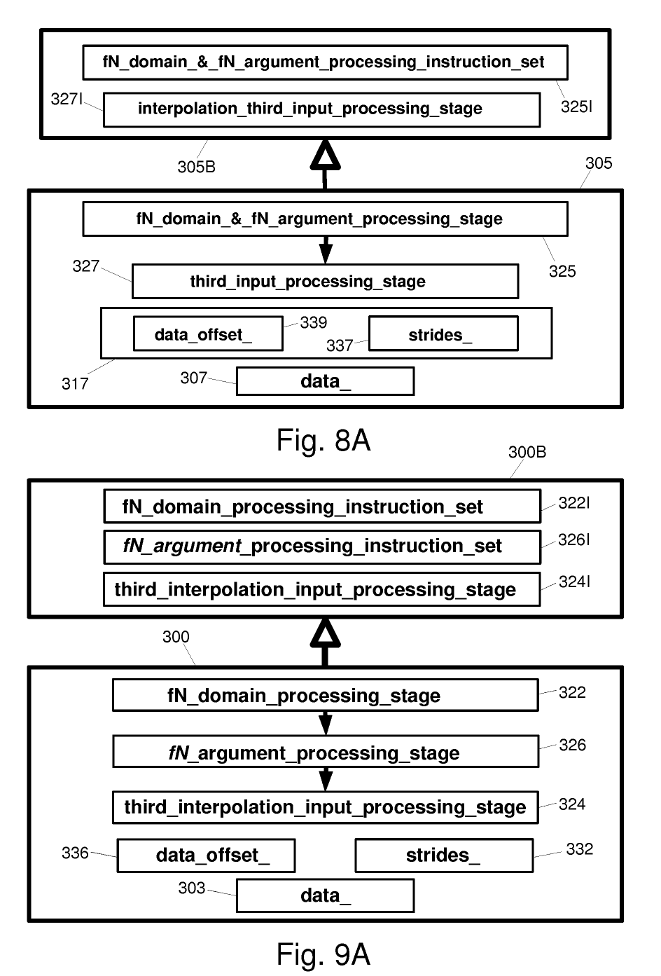

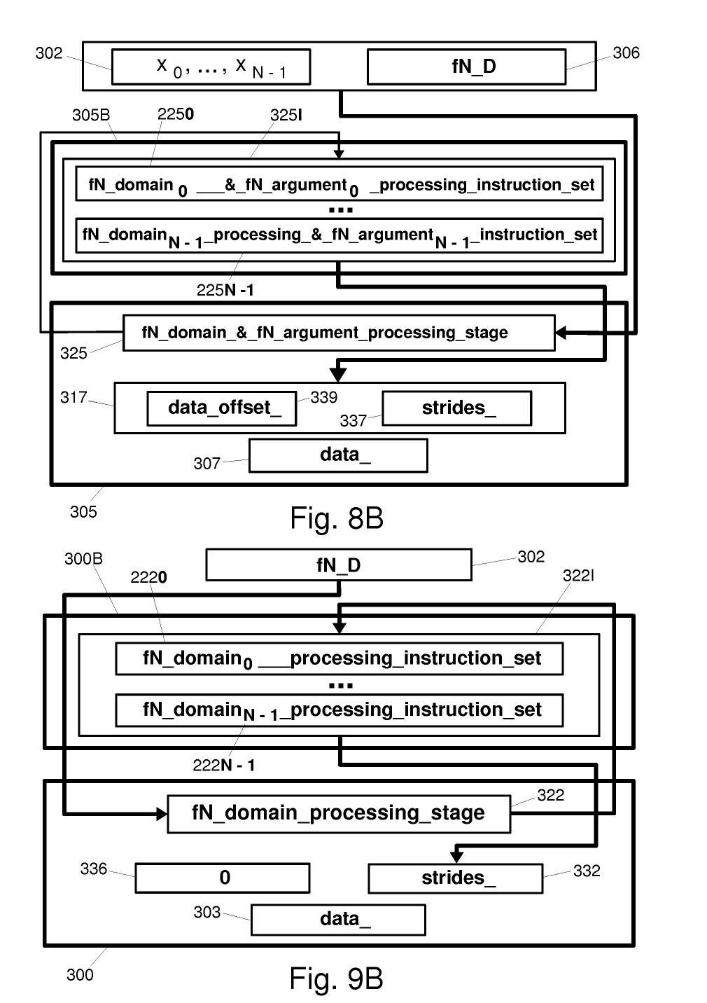

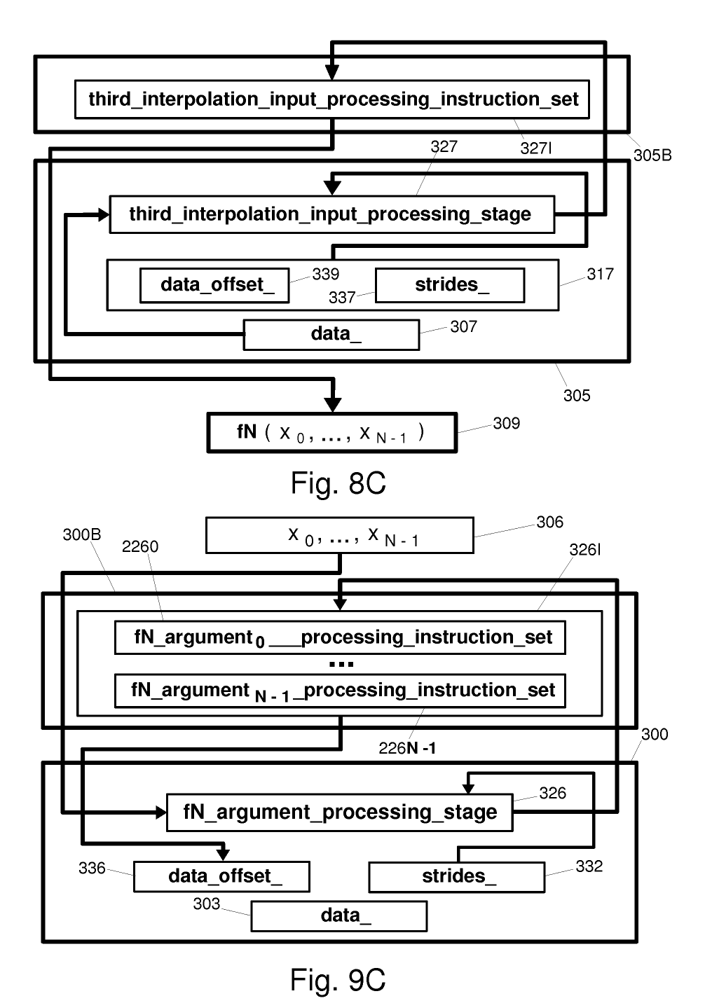

FIG. 8A shows an exemplary layout of interpolating function FN 305, that implements processing hierarchy (IIL) as follows:
Interpolating function FN 305 is shown inheriting from a base class 305B and being initialized with a data-base iterating-means data_{—} 307 (e.g., a pointer means or a random access iterator means) pointing to interpolating function FN call-specific, argument-node-value-adjusted data-base origin.

FIG. 8A also depicts interpolating function FN 305 instruction set being code-partitioned into two sequentially performed processing stages—a processing stage 325 dedicated to processing interpolated function fN domain (i.e. first interpolation input) and interpolated function fN associated argument value (i.e. second interpolation input), and a processing stage 327 dedicated to processing interpolating function's FN third-interpolation input.

FIG. 8A also depicts base interpolation object's 305B instructions set being code-partitioned into two instruction subsets—instruction set 325I dedicated to implementing function's FN 305 first interpolation stage 325, and instruction set 327I dedicated to implementing function's FN 305 second interpolation stage 327.

The layout shown in FIG. 8A is necessarily hardware-supported:

As shown in FIG. 8A, a storage space 317 is allocated in a computer storage medium within object 305, said storage space 317 containing: interpolating function's FN first data unit strides_{—} 337 used for storing function FN 305 lexicographically-ordered data-base's set of strides, and interpolating function FN 305 second data unit, data_offset_{—} 339 used to offset interpolation data-base origin in accordance with interpolating function Fn second argument value (i. e. function fN associated argument node 306).

In accordance with the (IIL) code-partitioning scheme, FIG. 8B depicts interpolating function's FN 305 first processing stage being implemented to sequentially call, upon receiving an argument node value 306 and function fN domain 302, each of nested interpolating functions' FNᵢ first instruction sets 225i. (FIG. 6B).

In accordance with the (IIL) global code-partitioning scheme, FIG. 8C depicts interpolating function's FN 305 instruction set 327 processing function's FN 305 third interpolation-input and returning interpolated function's fN value 309 at input argument node 306: at this point of description performing function FN 305 third interpolation-input processing stage is shown as being partitioned out by default.

### Eliminating Redundant Input-Processing in Multi-Dimensional Interpolation Globally

In accordance with yet another feature of this invention, we have discerned, and demonstrated in the present invention preferred embodiments, that eliminating redundant data processing in multi-dimensional interpolation can be computer-implemented by:

(I) processing the interpolation first interpolation input prior to processing the interpolation second interpolation input, and

(II) processing the interpolation second interpolation input prior to processing the interpolation third interpolation input.

### Processing Sequence (I)-and-(II): Global-To-Local/Local-To-Global Structural Links

Once interpolating function FN processing sequence has been (I)-and-(II)-code-partitioned, it breaks up into N interpolation-stage-specific local processing chronologies, each mandating:
processing interpolating function FNᵢ first argument value prior to processing function FNᵢ second argument value, and
processing interpolating function FNᵢ second argument value prior to
processing function FNᵢ third argument values.

In accordance with the present invention yet another feature, we observe that the above described local interpolation-input processing hierarchies, which are global-interpolation-input-makeup-imposed, are structurally identical to local-input processing hierarchies 400i, which are local-input-stratified-incidence-rates-imposed (FIG. 7A).

Thus, in accordance with the present invention yet another feature, we observe that locally-optimized processing hierarchies 400i are mandated by globally-optimized processing sequence (I)-and-(II).

Thus, we observe, eliminating redundant input-processing in multi-dimensional interpolation is predicated on both local interpolation-input makeup and global interpolation-input makeup. Thus, eliminating redundant input-processing in multi-dimensional interpolation is predicated on interpolation-input makeup as a whole.

### Computer-Implementating Processing Sequence (I)-(II).

We further observe that jointly-extended local-input-processing-hierarchies 405i define global processing hierarchies (I) and (II). That also means that this structural connection can serve as a blueprint as to how global input processing hierarchy (I)-and-(II) could be implemented.

FIG. 9A shows an exemplary layout of interpolating function/object FN 300 that implements processing sequence (I)-and-II) as follows:
Interpolating function FN 300 inherits from a base class 300B. Interpolating function FN 300 is initialized with an interpolation data-base-iterating means data_ 303 (e.g., a pointer means or a random access iterator means) pointing to interpolating function FN call-specific, argument-node-value-adjusted data-base origin.

FIG. 9A also depicts object 300 instruction set being code-partitioned into three sequentially performed processing stages—a processing stage 322 dedicated to processing interpolated function fN domain (i.e. interpolating function's FN first interpolation-input), a processing stage 326 dedicated to processing interpolated function fN associated argument value (i.e. interpolating function's FN second interpolation-input), and a processing stage 324 dedicated to processing interpolating function's FN third interpolation-input.

FIG. 9A also depicts base object's 300B instruction set being code-partitioned into three instruction subsets—instruction set 322I dedicated to implementing function's FN first interpolation stage 322, instruction set 326I dedicated to implementing function's FN second interpolation stage 326. and instruction set 324I dedicated to implementing function's FN third interpolation stage 324.

The layout shown in FIG. 9A is necessarily hardware-supported:

As shown in FIG. 9A, a first and a second storage spaces are allocated in a computer storage medium within interpolating object 300, the first storage space containing interpolating function's FN first data unit strides_{—} 332, data unit strides_ in turn storing interpolated function fN range's list of strides, and the second storage space containing interpolating function FN second data unit data_offset_{—} 336 used to shift interpolation data-base origin depending on interpolating function FN second argument value.

In accordance with the (I)-(II) global code-partitioning scheme, FIG. 9B depicts interpolating function's FN first processing stage 322 computer-implemented to sequentially call, upon receiving interpolated function fN domain 302 (FIG. 3), interpolating functions' FN_{I} 200i locally-code-partitioned first instruction sets 222i (FIG. 7B).

In accordance with the (I)-(II) global processing sequence, FIG. 9C depicts interpolating function's FN second processing stage 326 computer-implemented to sequentially call, upon receiving interpolated function fN domain associated argument value 306, interpolating function FNᵢ locally-code-partitioned second instruction sets 226i (FIG. 7C).

In accordance with the (I)-and-(II) global code-partitioning scheme, FIG. 9D depicts interpolating function's FN 300 instruction set 324 processing function's FN 300 third interpolation-input and returning interpolated function's fN value 308 at input argument node 306: at this point of the description performing function FN 300 third interpolation-input processing stage is shown as being partitioned out by default.

### Processing Third Interpolation Input as a Recursion. Processing Third Interpolation Input as a Recursion: Dimensional-Reduction Means

As we recall, we (a) have implemented globally optimized processing sequence (IIL) by jointly-extending two-stage local input processing hierarchies 405i, and (b) have implemented globally optimized processing sequence (I)-(II) by jointly-extending three-stage local input processing hierarchies 400i.

As we have discerned in accordance with the present invention yet another feature, jointly-extending either local input processing hierarchies 400i or local input processing hierarchies 400i means that by the time processing third interpolation-input begins, all of functions FN_{I}, either 200i or 205i , are reduced to tangibly implemented numerical functions FNᵢ (FIGS. 6D and 6E, FIGS. 7E, 7F).

Thus, we have discerned, and demonstrated in the present invention embodiments, that by merely processing function FN third interpolation-input after function FN first and second interpolation-inputs have been processed, reduces all of nested interpolating functions FN_{I} to numerical function FNᵢ serving as sequentially applied dimensional-reduction means (FIGS. 8D and 9E).

Thus, as we have discerned, in a yet another of this invention's inventive steps, that
processing function FN third interpolation-input after function FN first and second interpolation-inputs have been processed enables processing function FN third interpolation-input as a recursion.
   Thus, as we have discerned and demonstrated in the present invention's embodiments, implementing processing function FN third interpolation-input as a recursion is predicated on interpolation dynamic-input makeup.

### Processing Third Interpolation Input As A Recursion: A Flowchart

Without loss of generality, both for illustrative purposes and in order to facilitate understanding of structures associated with processing third interpolation input by a person skilled in the art, we will again be using exemplary three-dimensional interpolating function F3 we have introduced earlier in the description (FIG. 2B).

FIG. 8C shows a flow-chart 900 of interpolating function F3 305, being implemented by algorithmically-global nested interpolation objects 200E0, 200E1, and 200E2 in accordance with processing hierarchy (IIL), function F3 305 processing its third-interpolation-input upon having its first and second interpolation-inputs processed.

FIG. 8C also shows object 200E2 returning interpolated function f3 value 308E at an argument node 306E.

FIG. 9E shows a flow-chart 900L of interpolating function F3 300, implemented by algorithmically-local nested one-dimensional interpolation objects 200L0, 200L1, and 200L2 in accordance with processing hierarchy (I)-and-(II), function F3 300 processing its third-interpolation-input, upon having its first and second interpolation-inputs processed.

FIG. 9E also shows object 200L2 returning interpolated function f3 value 308LE at an argument node 306E.

### Processing Third Interpolation Input as a Recursion: Parsing an Interpolated Function Range

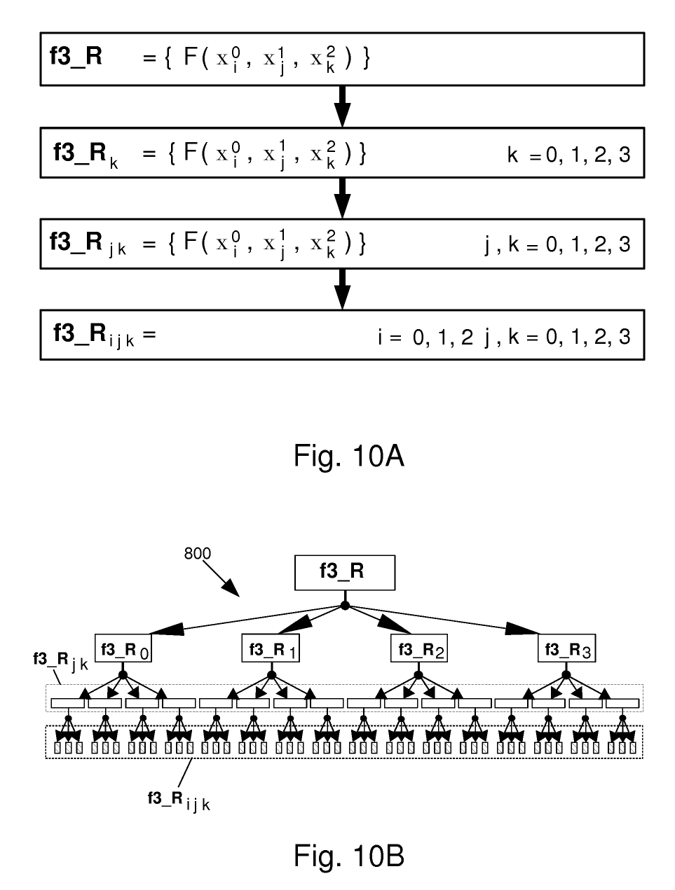

FIG. 10A shows a four-stage parsing of three-dimensional lexicographically ordered data-base 302E (FIG. 1).

FIG. 10B depicts a split-down flow-chart 800 of lexicographically-ordered data-base 302E so parsed.

### Processing Third Interpolation Input as a Recursion: A Split-Down/Push-Up Recursive Scheme

In accordance with the present invention's yet another feature, we have discerned that computer-implemented data-base-parsing split-down flow-chart 800 and computer-implemented third-interpolation-input-processing push-up flow-chart 900 feature identical topologies.

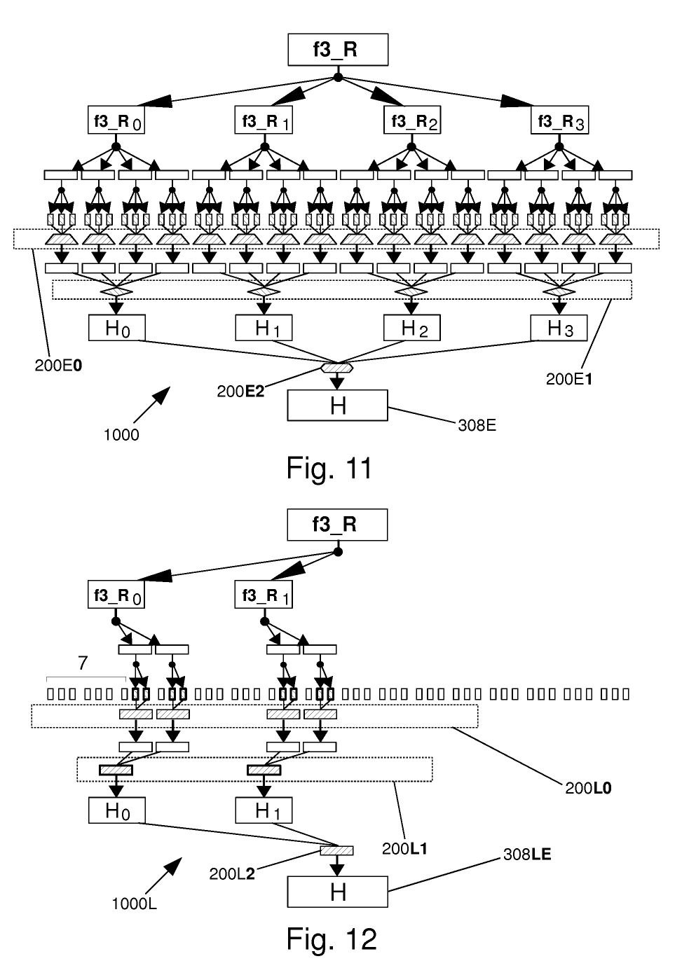

In accordance with the present invention's yet another feature, we have discerned, and demonstrated in this invention's embodiments, that computer-implemented split-down data-parsing flowchart 800 and computer-implemented data-processing push-up flow-chart 900 can be merged into a split-down/push-up computer-implemented recursion scheme 1000 (FIG. 11)

Also, in accordance with the present invention's yet another feature, we have discerned, and demonstrated in this invention's embodiments, that computer-implemented flowchart 800 and computer-implemented flow-chart 900L can be merged into a split-down/push-up computer-implemented recursion scheme 1000L (FIG. 12).

### Processing Third Interpolation Input as a Split-Down/Push-Up Recursion: Advantages

Implementing either processing sequence (IIL) or processing sequence (I)-and-(II) means eliminating redundant data-processing in multi-dimensional interpolation, either completely or substantially as described.

Moreover, as we have demonstrated in the present invention embodiments, implementing processing third interpolation input as a recursion also means eliminating substantially-redundant overhead caused by repeat constructs associated with implementing interpolation iteratively (e. g. multi-dimensional arrays, see W.H. Press et al., Numerical Recipes (The Art of Scientific Computing), 3rd Edition, Cambridge University Press, Chapter 3, “3.6 Interpolation on a Grid in Multidimensions,” 2007, pp. 132-139).

Moreover, in the present invention embodiments, processing an interpolation third interpolation-input is implemented as a tail recursion.

That means that said interpolation is redundant stack-grows free, substantially as described.

### Efficiently Implementing Interpolation in Multiple Dimensions in a Distributed Computing Environment is Predicated on Dynamic Interpolation-Nput Makeup

Amdahl's law [of diminished returns] limits the speed increase obtainable through parallel-processing regardless of how many processors are used if serial portions of the program are not improved. Means for interpolating in multiple dimensions implemented in the present invention's embodiments feature no serial portions.

That means that in a parallel processing system, gains in performance provided by implementing interpolation in accordance with this invention features, grow in a direct proportion to the number of processing nodes used.

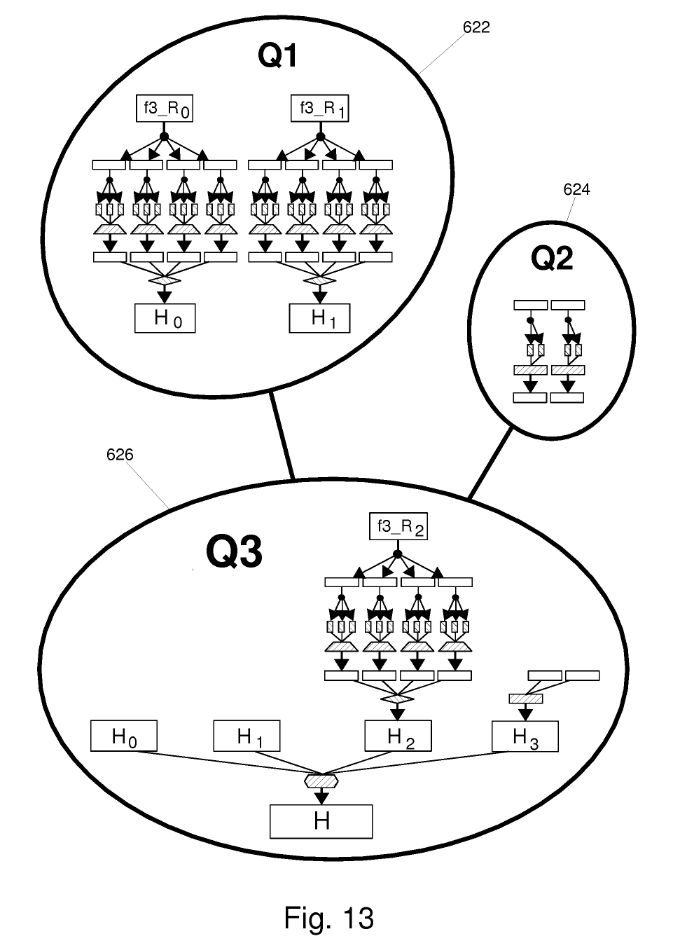

FIG. 13 provides an illustrative layout of a three-node computer system in communication over a network comprising a single node computing system, Q1 622, a single node computing system Q2 624, and a single node computing system Q3 626, each featuring at least one processing unit, each operating over a local memory, each storing and processing a sub-hierarchy of the hierarchy 304E, jointly performing a single interpolation call (FIGS. 1, 10A, and 10B, 11).

Since implementing processing interpolation third interpolation input as a recursion is predicated on dynamic interpolation-input makeup, and since, as we have explained in the description, modularity of processing a multi-dimensional interpolation dynamic interpolation-input is predicated on processing the interpolation third interpolation input as a recursion, all of the above means that efficiently computing thus implemented interpolation in a parallel computing environment is predicated on dynamic interpolation-input makeup as well.

Additional information pertaining to pertaining to the illustrative embodiments shown and described hereinabove is contained in U.S. Provisional Patent Application Ser. No. 61/174,373, filed Apr. 30, 2009, and incorporated by reference.

### Means for Computer-Generating Interpolaton Means of a User Defined Type: The Apparatus

One of this invention objects is to provide method and system for computer-generating means of multi-dimensional interpolation of a user-defined type implemented in accordance with the present invention features.

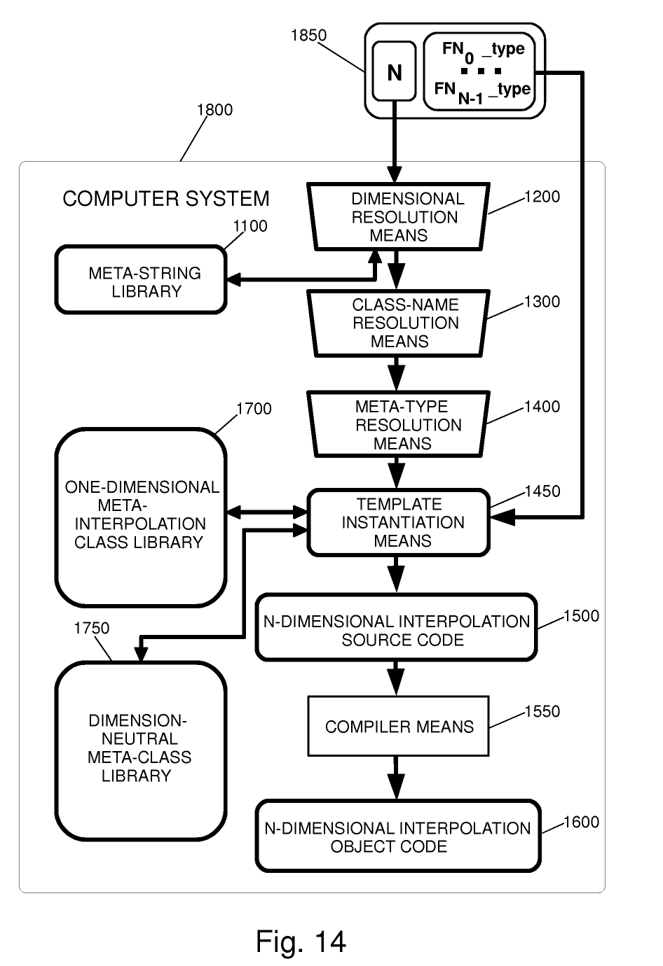

FIG. 14 depicts an exemplary layout of such an system:

FIG. 14 shows a specially configured computer system 1800 comprising:
a dimensional-resolution means 1200,
a class-name resolution means 1300,
a meta-type resolution means 1400,
a template-instantiation means 1450, and
a compiler means 1550.

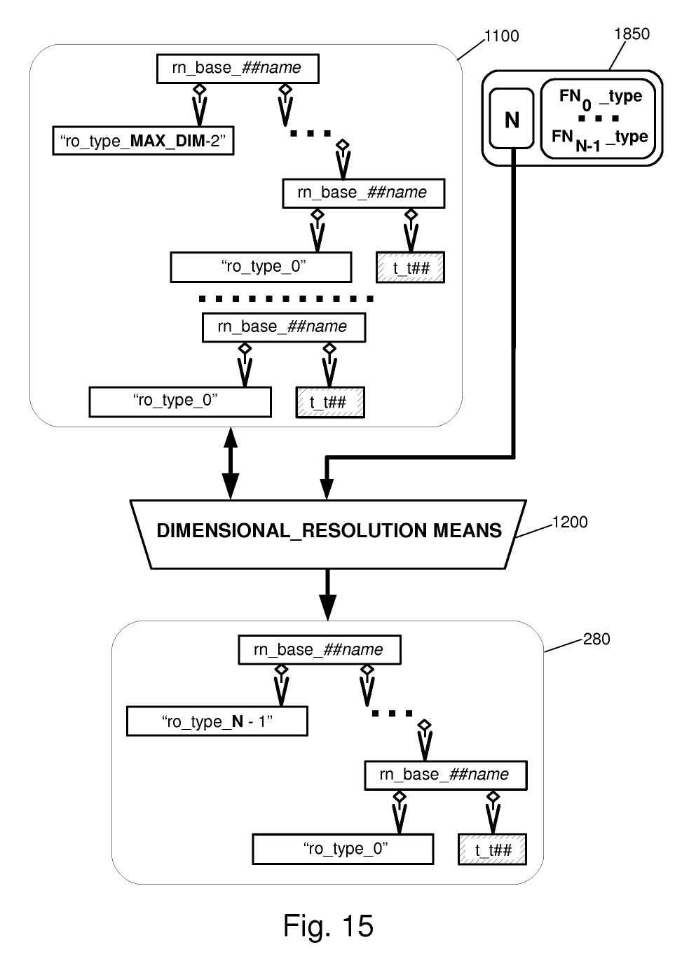

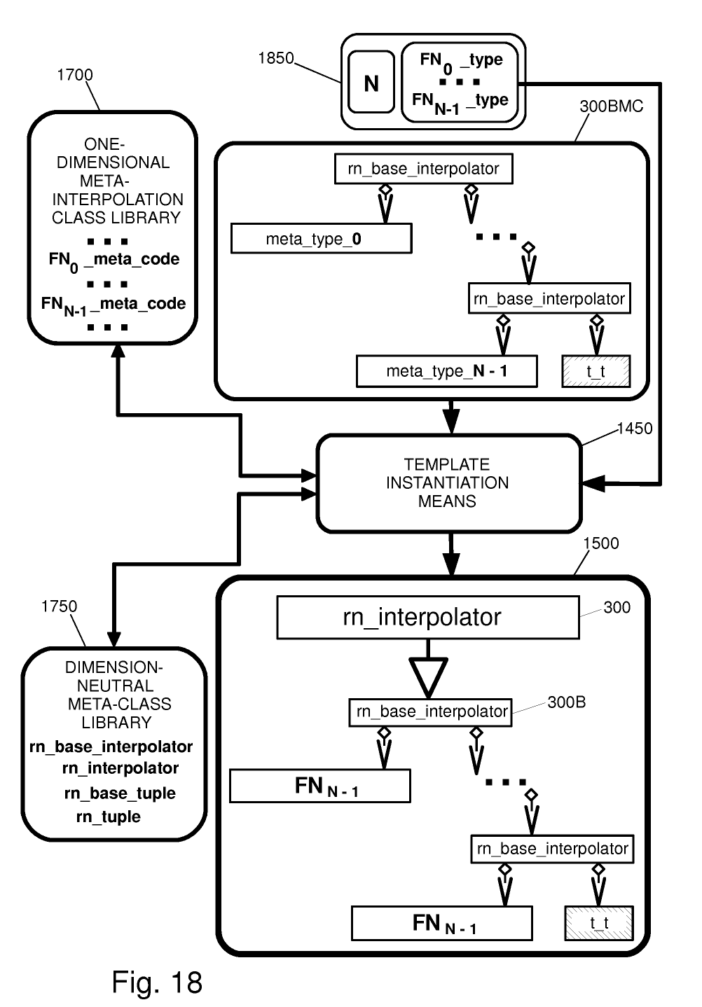

FIG. 14 also show system 1800 permanently storing, in a computer storage medium within the system:
a recursively-expanding meta-string library 1100, the library strings meta-recursive depth ranging from one to MAX_DIM (FIGS. 14 and 15),
a one-dimensional meta-interpolation library 1700 comprising: an expandable plurality of one-dimensional meta-interpolation source code segments ((FIGS. 14 and 18),
a dimension-neutral meta-class library 1750 comprising a fixed plurality of one-dimensional meta-class source code segments (e.g. rn_base_tuple code segment, or rn_base_tuple code segment) ((FIGS. 14 and 18).

### Means for Computer-Generating Interpolaton Means of a User Defined Type: The Method

Without loss of generality and for illustrative purposes, we will delineate the process of computer-generating an interpolating function of any type and of any dimension using an example of N-dimensional interpolating function FN 300 of FIG. 9A which, besides being computer-generated, will be implemented in accordance with the present invention features.

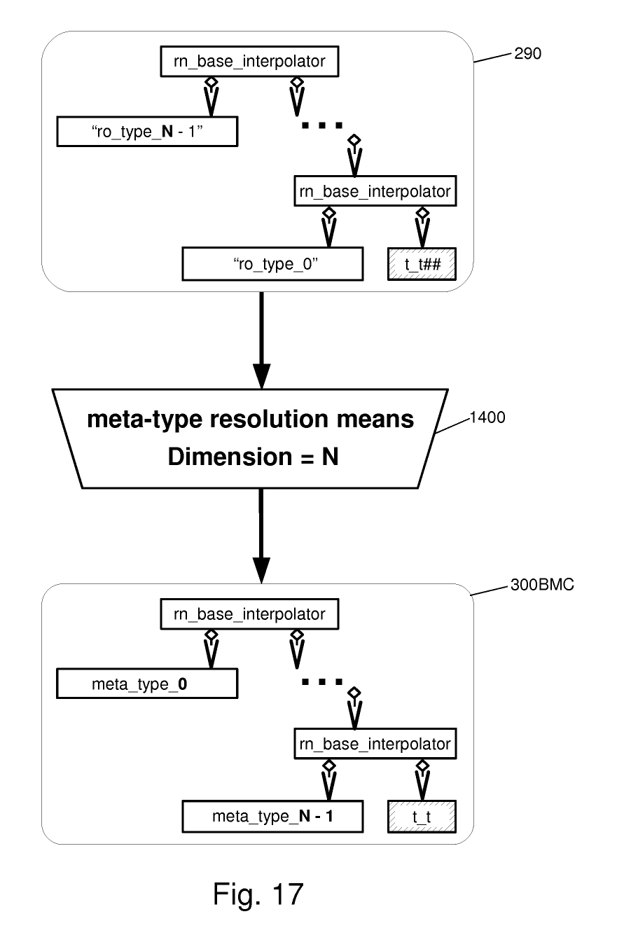

FIGS. 14, 15, 16, 17, and 18 show a process of computer-generating function FN 300, the process comprising the computer-implemented steps of:

(a) entering into a computer system 1800 the user-input comprising:
the number N of interpolation dimensions, and a list of N one-dimensional interpolation types for implementing each of the N interpolation stages of to-be-generated N-dimensional interpolation (FIGS. 14, 15, and 18),

(b) applying dimensional-resolution means 1200 for copying a meta-string 380 of recursive depth N from a meta-string library 1100 and storing thus-copied meta-string 380 in a computer readable-writable storage medium within system 1800 (FIG. 15),

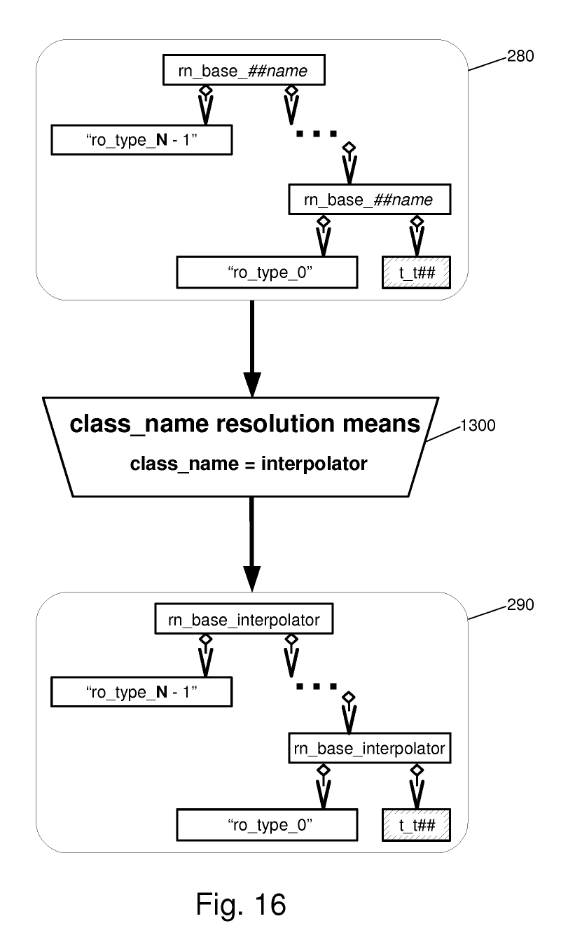

(c) applying class-name resolution means 1300 for resolving said meta-string 380 into a meta-class-string 390 associated with class name “interpolator” and storing said meta-class-string in a computer-readable medium within computer-system 1800 (FIG. 16),

(d) applying meta-type resolution means for further resolving meta-class-string 309 into a meta-class 300BMS associated with class name “rn_base_interpolator”, said meta-class recursively defined, dimension-neutral source-code instruction set being permanently stored in a computer-readable medium within computer-system 1800 (FIGS. 14 and 18),

(e) applying template-instantiation-means 1450 for generating a source-code 1500 associated with said meta-class in accordance with said user-supplied type-list (FIG. 18),

(f) applying compiler-means 1550 for generating an object-code 1600 associated with source code 1500 and storing object code 1600 in a computer-readable storage medium within computer system 1800.

### INDUSTRIAL APPLICABILITY

As demonstrated in in this invention's embodiments, in comparison to prior art benchmarks, gains in interpolation speed that the present invention's embodiments offer measure in orders of magnitude.

Case in point, Kenneth Johnson implements a multi-cubic spline algorithm (U.S. Pat. No. 7,043,397) that runs in 6.6 sec in the dimension six and provides accuracy order 2. A cubic bessel spline algorithm, as implemented in the dimension six in one of this invention preferred embodiments, runs in 0.005 sec, about one-thousand-three-hunted-times faster than multi-cubic spline implemented by Kenneth Johnson, and provides accuracy order 2 as well.

A rational polynomial algorithm implemented in the dimension six in one of this invention preferred embodiments runs in 0.014 sec, about five-hundred-times-faster than multi-cubic spline implemented by Kenneth Johnson and provides practical (as opposite to asymptotic) accuracy that is a four to five orders of magnitude better than accuracy provided by multi-cubic spline type algorithms.

Performance gains this invention embodiments provide are based on a number of contributing factors we have described hereinabove that at this point should be apparent to a person skilled in the art:
interpolating in multiple dimensions in a way that is redundant input-processing free [substantially as described],
processing third interpolation input as a recursion,
processing third interpolation input as a tail recursion,
processing third interpolation input in a way which is immune to the effects of Amdahl's law,
extending polynomial, rational polynomial interpolations, or any other interpolation capable of interpolating on sparse data bases in the dimension one, to interpolation in higher dimensions, thus reducing the size of a data-base required to interpolate over a given range by multiple orders of magnitude.

In a wide range of technological and scientific fields even incremental advances in multi-dimensional interpolation speed carry great weight.

The following is a short, and by no means complete, list of industries and scientific fields where the improvements this invention offers may have a dramatic impact:
image processing, color processing, color interpolation for computer graphics, color interpolation for visual displays, color interpolation for printing devices, microprocessor manufacturing, medical imaging, digital terrain mapping, geology, weather forecasting, climate change modeling, and oil exploration, among others.

Also, as demonstrated in the present invention embodiments, extending one-dimensional interpolation means, pre-implemented in accordance with the present invention features, to interpolation in any given dimension, can be done in a matter of minutes rather than months.

The opportunity this invention offers to instantaneously create means of interpolation in higher dimensions based on a library of pre-implemented one-dimensional interpolations which may be based on any one-dimensional algorithm, past, present, and future, may have a range of applications in financial research as well.

### BEST MODE FOR CARRYING OUT THE INVENTION

Like in the case of interpolating in the dimension one, where the choice of algorithms to be used is domain-specific, the choice of which one-dimensional algorithm(s) is (are) best suited for implementing an interpolation in multiple dimensions is domain-specific as well.

### OTHER MODES FOR CARRYING OUT THE INVENTION

The foregoing merely illustrates the principles of the invention.

For example, the illustrative embodiments shown and described hereinabove, are written in C++ computer language. Yet, implementations of multi-dimensional interpolation that are within the present invention scope and spirit can be written either in C++ computer language, differently, or in different computer languages, e.g., C, Scheme, Java, Smalltalk, D, and E.

As another example, it is possible to implement the illustrative embodiments shown and described hereinabove over a network, as a circuit, in a parallel processing computing environment, in firmware, or in any combination thereof.

As another example, the illustrative embodiments shown and described hereinabove are based on the fixed order in which interpolation input is processed. It should be apparent to a person skilled in the art that processing said order can be altered in numerous ways while still substantially preserving all of the gains offered by the present invention embodiments.

Moreover, in a multi-threaded environment, the actual order in which interpolation input is processed may vary from one interpolation run to another, as well as from one multi-threaded environment to another.

As another example, some of illustrative embodiments shown and described hereinabove are implemented on multi-node computer systems in communication over a network (FIG. 13). Yet, the present invention embodiments can be implemented in other parallel computing environments, e.g., a multi-processor supercomputer for example.

Moreover, in a multi-processor parallel computing environment, processing interpolation input may be done in an order different from that of processing interpolation input implemented on a single mode computer system.

As yet another example, some of illustrative embodiments shown and described hereinabove implement processing third interpolation input as a recursion. It is quite common to optimize recursion by converting it into a tail-recursion. And is quite common to optimize tail-recursion by transforming said tail-recursion calls into iteration calls.

As yet another example, some of illustrative embodiments shown and described hereinabove implement processing third interpolation input in a way that is redundant stack-grows free substantially as described. There are other ways (e.g. iterative ways) of implementing processing third interpolation input in a way that is redundant stack-grows free, substantially as described.

As yet another example, some of illustrative embodiments shown and described hereinabove implement interpolation in multiple dimensions in a way that renders a single multi-dimensional interpolation call redundant input-processing free.

As demonstrated in this invention's preferred embodiments, eliminating redundant input-processing in a single multi-dimensional interpolation call can be extended to eliminating redundant input-processing in said interpolation across said interpolation multiple calls.

It will thus be appreciated that those skilled in the art will be able to devise numerous arrangements which, although not explicitly shown or described herein, embody the principles of the invention and are thus within the present invention's scope and spirit.

What is claimed is:

1. A method for efficiently implementing a multi-dimensional interpolation, the method comprising
implementing said interpolation in a way which is predicated on dynamic interpolation-input makeup.

2. The method of claim 1, the method further comprising
processing, said interpolation's first interpolation-input and said interpolation's second interpolation-input, prior to processing said interpolation's third interpolation-input,
processing said interpolation's third interpolation-input as a recursion.

3. The method of claim 1, the method further comprising
processing said interpolation's first interpolation-input prior to processing said interpolation's second interpolation-input,
processing said interpolation's second interpolation-input prior to processing said interpolation's third interpolation-input,
processing said interpolation's third interpolation-input as a recursion. 11

4. A method for efficiently implementing a multi-dimensional interpolation, the method comprising
processing said interpolation's third interpolation-input as a recursion.

5. The method of claim 4, the method further comprising
implementing said interpolation in a way which renders said interpolation redundant input-processing free.

6. The method of claim 4, the method further comprising implementing said interpolation in a way which renders said interpolation redundant stack-grows free, substantially as described.

7. A method for efficiently implementing a multi-dimensional, the method comprising
implementing said interpolation in a way which renders said interpolation redundant input-processing free, substantially as described.

8. The method of claim 7, the method further comprising
implementing said interpolation in a way which renders said interpolation redundant overhead free, substantially as described.

9. The method of claim 7, the method further comprising implementing said interpolation in a way which renders said interpolation redundant stack-grows free, substantially as described.

10. The method of claim 7, the method further comprising implementing said interpolation in a way which renders said interpolation redundant input-processing free.

11. The method of claim 7, the method further comprising processing said interpolation's third interpolation-input as a recursion.

12. The method of claim 10, the method further comprising implementing said interpolation in a way which renders said interpolation redundant overhead free, substantially as described.

13. The method of claim 10, the method further comprising implementing said interpolation in a way which renders said interpolation redundant stack-grows free, substantially as described.

14. The method of claim 10, the method further comprising processing said interpolation's third interpolation-input as a recursion.

15. The method of claim 14, the method further comprising implementing said interpolation in a way which renders said interpolation redundant input-processing free.

16. The method of claim 14, the method further comprising implementing said interpolation in a way which renders said interpolation redundant stack-grows free, substantially as described.

17. The method of claim 11, the method further comprising implementing said interpolation in a way which renders said interpolation redundant input-processing free.

18. The method of claim 11, the method further comprising implementing said interpolation in a way which renders said interpolation redundant stack-grows free, substantially as described.

19. A program storage device, tangibly embodying a program of instructions executable by a machine to perform a method for efficiently implementing a multi-dimensional interpolation in accordance with claim 1.

20. A program storage device, tangibly embodying a program of instructions executable by a machine to perform a method for efficiently implementing a multi-dimensional interpolation in accordance with claim 2.

21. A program storage device, tangibly embodying a program of instructions executable by a machine to perform a method for efficiently implementing a multi-dimensional interpolation in accordance with claim 3.

22. A program storage device, tangibly embodying a program of instructions executable by a machine to perform a method for efficiently implementing a multi-dimensional interpolation in accordance with claim 6.

23. A program storage device, tangibly embodying a program of instructions executable by a machine to perform a method for efficiently implementing a multi-dimensional interpolation in accordance with claim 8.

24. A program storage device, tangibly embodying a program of instructions executable by a machine to perform a method for efficiently implementing a multi-dimensional interpolation in accordance with claim 9.
